(19) United States
(12) Patent Application Publication
(10) Pub. No.: US 2007/0250563 A1
(43) Pub. Date: Oct. 25, 2007

(54) SYSTEM, METHOD AND COMPUTER READABLE MEDIUM FOR PROVIDING A VISUAL STILL WEBPAGE IN AN ONLINE ANALYTICAL PROCESSING (OLAP) ENVIRONMENT

(76) Inventor: Ming-Che Lo, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/550,311

(22) Filed: Oct. 17, 2006

(30) Foreign Application Priority Data
Apr. 20, 2006 (TW) 095114068

(51) Int. Cl. G06F 15/16; G06F 17/00

(52) U.S. Cl. 709/203; 715/513; 709/206; 715/500; 715/505

(57) ABSTRACT

A system, a method and a computer readable medium for providing a visual still webpage in an online analytical processing (OLAP) environment while a user is utilizing the webpage. The present invention can achieve following steps: when the user end computer processes the webpage and triggers a request to the server end computer for obtaining data, the user end computer generating a hidden HTML IFrame and specifying a processing function for the user end computer after the server end computer processes the request; dynamically generating a hidden HTML Form in the HTML IFrame, assigning an action to a processing webpage of the server end computer, and setting the HTML IFrame as a target; dynamically generating an HTML Input in the HTML Form for sending a command or a parameter of the request; sending the command or the parameter of the HTML Form to the processing webpage of the server end computer; after receiving the command or the parameter, the server end computer decoding the command or the parameter; according to the command or the parameter, executing a related processing function; obtaining feedback data or graphical HTML data and packing the feedback data or graphical HTML data in an XML with response format message; sending the XML with response format message back to the user end computer; after receiving the XML with response format message, the HTML IFrame of the user end computer decoding the feedback data or graphical HTML data; and calling the processing function assigned to the HTML IFrame, processing the obtained feedback data or graphical HTML data, and displaying the result on the webpage of the user end computer.

### BACKGROUND OF THE INVENTION

1. Field of the Invention

The present invention relates to a system, a method and a computer readable medium; and, more particularly, to a system, a method and a computer readable medium for providing a visual still webpage in an online analytical processing (OLAP) environment.

2. Description of the Related Art

In the prior art technology, when a user utilizes a webpage program in a web-based OLAP environment, for example, when requesting data from a server, the user end computer typically pops up or opens a new webpage, or updates the original webpage, to display on the new webpage feedback data from the server.

Therefore, utilizing a webpage program in a web-based OLAP environment is different from utilizing a general program in an offline environment, since the webpage in the web-based OLAP environment may need to be updated or refreshed.

It is therefore desirable to provide a system, a method and a computer readable medium for providing a visual still webpage in an online analytical processing (OLAP) environment to mitigate and/or obviate the aforementioned problems.

### SUMMARY OF THE INVENTION

An objective of the present invention is to provide a system, a method and a computer readable medium for providing a visual still webpage in an online analytical processing (OLAP) environment.

The system of the present invention comprises a user end computer and a server end computer, wherein the user end computer and the server end computer are connected via a network and adapted to perform the following steps:

1. when the user end computer processes the webpage and triggers a request to the server end computer for obtaining data, the user end computer generating a hidden HTML IFrame and specifying a processing function for the user end computer after the server end computer processes the request;

2. dynamically generating a hidden HTML Form in the HTML IFrame, assigning an action to a processing webpage of the server end computer, and setting the HTML IFrame as a target;

3. dynamically generating an HTML Input in the HTML Form for sending a command or a parameter of the request;

4. sending the command or the parameter of the HTML Form to the processing webpage of the server end computer;

5. after receiving the command or the parameter, the server end computer decoding the command or the parameter;

6. according to the command or the parameter, executing a related processing function;

7. obtaining feedback data or graphical HTML data and packing the feedback data or graphical HTML data in an XML with response format message;

8. sending the XML with response format message back to the user end computer;

9. after receiving the XML with response format message, the HTML IFrame of the user end computer decoding the feedback data or graphical HTML data; and

10. calling the processing function assigned to the HTML IFrame, processing the obtained feedback data or graphical HTML data, and displaying the result on the webpage of the user end computer.

In one embodiment of the present invention, the webpage includes a multidimensional data table, and the multidimensional data table is a pivot table. Furthermore, a system, a method and a computer readable medium of the present invention can be applied in an online analytical processing (OLAP) environment.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of the present invention.

FIG. 2 is a flow chart of a method of the present invention.

FIG. 3 shows utilizing a webpage according to the present invention.

### DETAILED DESCRIPTION OF THE PREFERRED EMBODIMENT

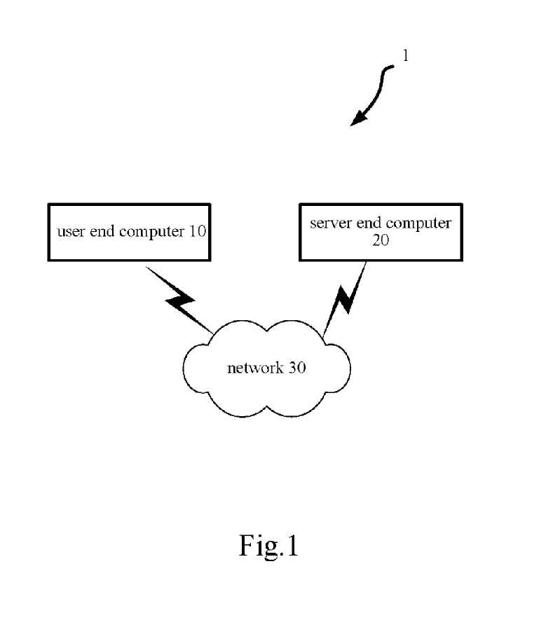

Please refer to FIG. 1. FIG. 1 is a schematic diagram of the present invention.

As shown in FIG. 1, a system 1 comprises a user end computer 10 and a server end computer 20. The user end computer 10 and the server end computer 20 are connected via a network 30, such as the Internet. In the system 1 of the present invention, when a user utilizes a webpage in an online analytical processing (OLAP) environment, the webpage can remain still.

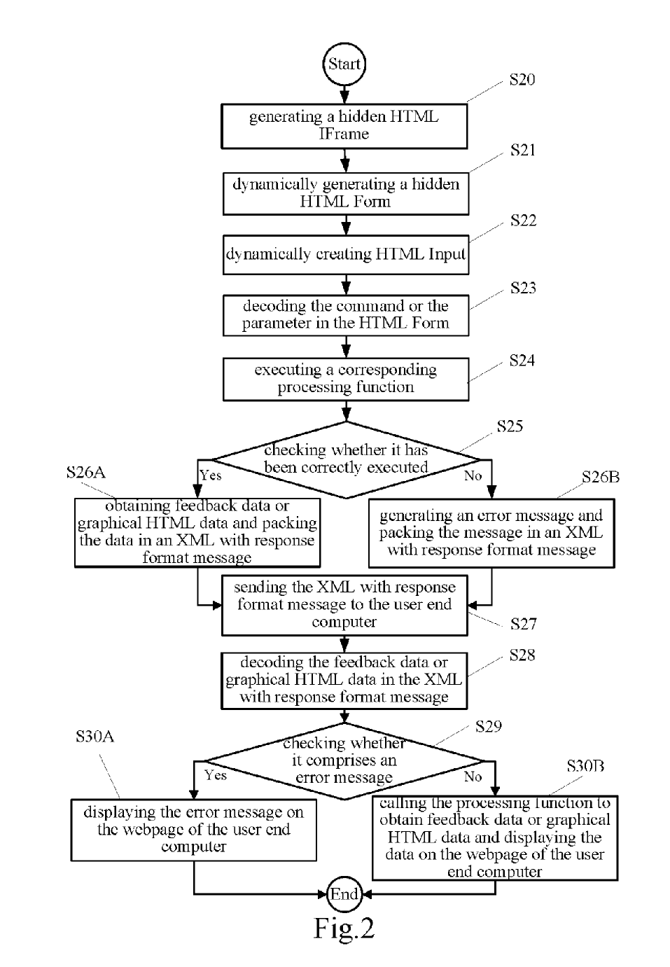

Next, please refer to FIG. 2. FIG. 2 is a flow chart of a method of the present invention. The method of the present invention provides the following steps, discussed below. As shown in FIG. 2, the method of the present invention comprises steps S20 to S30B.

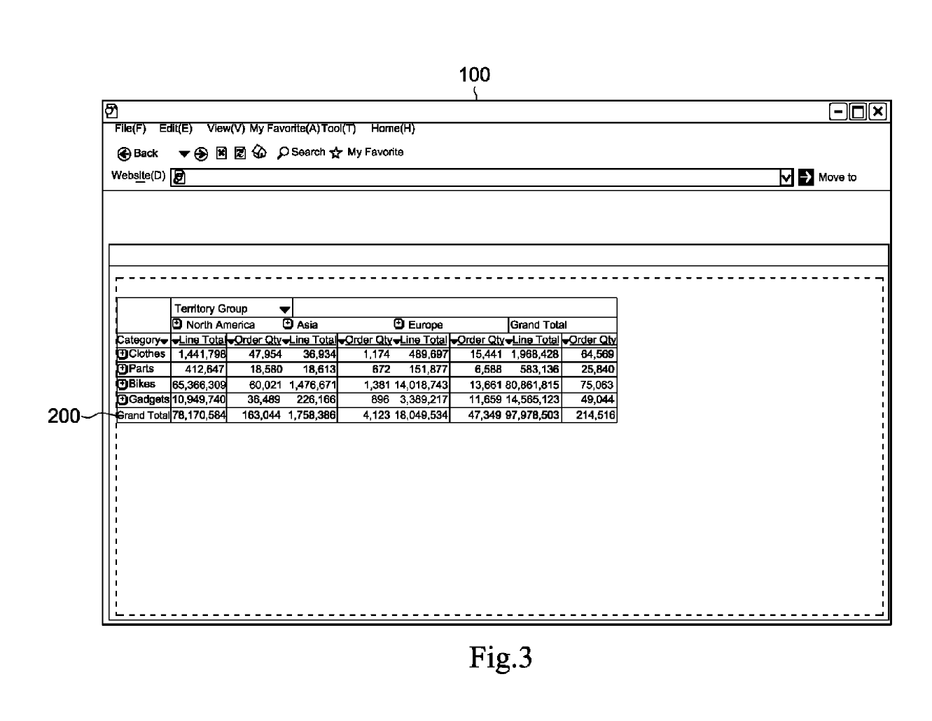

In step S20, when the user utilizes the webpage on the user end computer 10 in the OLAP environment, as shown in FIG. 3, different actions, such as opening, inserting, adding a new column, etc. can be performed on a pivot table 200 in the webpage 100, which all require that a request be sent to the server end computer 20 to obtain data. The user end computer 10 generates a hidden HTML IFrame and assigns a processing function for the user end computer 10 after the server end computer 20 has processed the request. Here, “hidden HTML IFrame” means that this HTML IFrame is not displayed on the user end computer 10 so that the user will not be able to see it.

After the HTML IFrame has been generated, in step S21, a hidden HTML Form is dynamically generated in the HTML IFrame on the user end computer 10; an action for the HTML Form is assigned to the processing webpage of the server end computer 20, and the target is set as the HTML IFrame. For example, the present invention may generate the HTML Form with the following program code:

<Form action=“to the processing webpage of the server end computer” target=“IFrame”>

Similarly, a “hidden HTML Form” means that this HTML Form is not displayed on the user end computer 10 so that the user will not be able to see it.

Next, in step S22, an HTML Input is dynamically created in the HTML Form for sending the command or the parameter included in the HTML Form to the processing webpage of the server end computer 20 for further processing.

In step S23, the command or the parameter included in the HTML Form is decoded by the server end computer 20. In step S24, based upon the command or parameter, the processing webpage of the server end computer 20 executes a corresponding processing function.

In step S25, the server end computer 20 checks whether the command or the parameter has been correctly executed by the processing webpage. If the command or the parameter was correctly executed, step S26A is performed. If the command or the parameter was not correctly executed, step S26B is performed.

Next, if the command or the parameter has been correctly executed, in step S26A, the processing webpage of the server end computer 20 executes the corresponding webpage and obtains feedback data or graphical HTML data and packs this data in an XML with response format message.

In step S25, if the command or the parameter has not been correctly executed, in step S26B an error message is generated and this error message is packed as an XML with response format message.

In step S27, the XML with response format message generated in step S26A, or the XML with response format message generated in step S26B, is sent back to the user end computer 10.

In step S28, the HTML IFrame of user end computer 10 receives the XML with response format message and decodes the feedback data or graphical HTML data packed in the XML with response format message.

In step S29, the user end computer 10 checks whether the feedback data or graphical HTML data decoded from the XML with response format message comprises an error message. If the feedback data or graphical HTML data includes an error message, step S30A is performed; and if the feedback data or graphical HTML data doesn't include an error message, step S30B is performed.

Next, if an error message occurred in step 29, step S30A is performed, and the error message is displayed on the webpage of the user end computer 10.

On the other hand, if no error message occurred in step S29, step S30B is performed, the processing function of the HTML IFrame assigned in step 20 is called and the obtained feedback data or graphical HTML data is processed and displayed on the webpage of the user end computer 10.

Therefore, with the system 1 and the above mentioned method of the present invention, as shown in FIG. 3, when a user utilizes a multidimensional data table 200 (such as clicking on “clothes” or “North America” options) on the webpage 100, only the corresponding numerical value “1,441,798” of “clothes” and “North America” option is updated, and the webpage 100 itself remains the same. Consequently, the image presented by the webpage 100 remains stationary.

In an embodiment of the present invention, the present invention is applied in a web-based OLAP environment, and the multidimensional data table 200 in FIG. 3 may be a pivot table 200. However, the technology of displaying the webpage and displaying the multidimensional data table or the pivot table on the webpage is a well-known technology, and requires no further explanation.

Finally, the present invention also provides a computer readable medium, which has a plurality of computer-executable commands for executing the above-mentioned method.

Although the present invention has been explained in relation to its preferred embodiment, it is to be understood that many other possible modifications and variations can be made without departing from the spirit and scope of the invention as hereinafter claimed.

What is claimed is:

1. A system for providing a visual still webpage in an online analytical processing (OLAP) environment while a user is utilizing the webpage, the system comprising a user end computer and a server end computer, the user end computer and the server end computer are connected via a network and adapted to perform the following steps:
when the user end computer processes the webpage and triggers a request to the server end computer for obtaining data, the user end computer generating a hidden HTML IFrame and specifying a processing function for the user end computer after the server end computer processes the request;
dynamically generating a hidden HTML Form in the HTML IFrame, assigning an action to a processing webpage of the server end computer, and setting the HTML IFrame as a target;
dynamically generating an HTML Input in the HTML Form for sending a command or a parameter of the request;
sending the command or the parameter of the HTML Form to the processing webpage of the server end computer;
after receiving the command or the parameter, the server end computer decoding the command or the parameter;
according to the command or the parameter, executing a related processing function;
obtaining feedback data or graphical HTML data and packing the feedback data or graphical HTML data in an XML with response format message;
sending the XML with response format message back to the user end computer;
after receiving the XML with response format message, the HTML IFrame of the user end computer decoding the feedback data or graphical HTML data; and
calling the processing function assigned to the HTML IFrame, processing the obtained feedback data or graphical HTML data, and displaying the result on the webpage of the user end computer.

2. The system as claimed in claim 1, wherein the user end computer and the server end computer are further adapted to perform the following steps:
examining whether the command or the parameter is correctly executed by the server end computer; and
if the command or the parameter is correctly executed, obtaining the feedback data or graphical HTML data.

3. The system as claimed in claim 2, wherein if the command or the parameter is not correctly executed, the server end computer packs an error message in an XML with response format message.

4. The system as claimed in claim 1, wherein the user end computer and the server end computer are further adapted to perform the following steps:
checking whether the feedback data or graphical HTML data decoded from the XML with response format message comprises an error message by the user end computer; and
if the error message is included, the error message is displayed on the webpage of the user end computer.

5. The system as claimed in claim 1, wherein the webpage of the user end computer comprises a multidimensional data table.

6. The system as claimed in claim 5, wherein the multidimensional data table is a pivot table.

7. A method for providing a visual still webpage in an online analytical processing (OLAP) environment while a user is utilizing the webpage, the method comprising:
when the user end computer processes the webpage and triggers a request to the server end computer for obtaining data, the user end computer generating a hidden HTML IFrame and specifying a processing function for the user end computer after the server end computer processes the request;
dynamically generating a hidden HTML Form in the HTML IFrame, assigning an action to a processing webpage of the server end computer, and setting the HTML IFrame as a target;
dynamically generating an HTML Input in the HTML Form for sending a command or a parameter of the request;
sending the command or the parameter of the HTML Form to the processing webpage of the server end computer;
after receiving the command or the parameter, the server end computer decoding the command or the parameter;
according to the command or the parameter, executing a related processing function;
obtaining feedback data or graphical HTML data and packing the feedback data or graphical HTML data in an XML with response format message;
sending the XML with response format message back to the user end computer;
after receiving the XML with response format message, the HTML IFrame of the user end computer decoding the feedback data or graphical HTML data; and
calling the processing function assigned to the HTML IFrame, processing the obtained feedback data or graphical HTML data, and displaying the result on the webpage of the user end computer.

8. The method as claimed in claim 7 further comprising:
examining whether the command or the parameter is correctly executed by the server end computer; and
if the command or the parameter is correctly executed, obtaining the feedback data or the graphical HTML data.

9. The method as claimed in claim 8, wherein if the command or the parameter is not correctly executed, the server end computer packs an error message in the XML with response format message.

10. The method as claimed in claim 7 further comprising:
checking whether the feedback data or graphical HTML data decoded from the XML with response format message comprises an error message by the user end computer; and
if the error message is included, displaying the error message on the webpage of the user end computer.

11. The method as claimed in claim 7, wherein the webpage of the user end computer comprises a multidimensional data table.

12. The method as claimed in claim 11, wherein the multidimensional data table is a pivot table.

13. A computer readable medium having a plurality of computer executable commands for executing the method claimed in claim 7.

14. A computer readable medium having a plurality of computer executable commands for executing the method claimed in claim 8.

15. A computer readable medium having a plurality of computer executable commands for executing the method claimed in claim 9.

16. A computer readable medium having a plurality of computer executable commands for executing the method claimed in claim 10.

17. A computer readable medium having a plurality of computer executable commands for executing the method claimed in claim 11.

18. A computer readable medium having a plurality of computer executable commands for executing the method claimed in claim 12.
